(19) United States
(12) Patent Application Publication
(10) Pub. No.: US 2008/0037156 A1
(43) Pub. Date: Feb. 14, 2008

(54) Combined servo controller for an actuator and a tray motor of an optical drive system

(76) Inventors: Sung-Yao Lin, Taipei County (TW); Jung-Tsung Cheng, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/836,151

(22) Filed: Aug. 9, 2007

(30) Foreign Application Priority Data
Aug. 9, 2006 (TW) 095129173

(51) Int. Cl. G11B 21/02

(52) U.S. Cl. 360/75

(57) ABSTRACT

A control system controlling the tilt actuator and the tray motor of a optical disk drive includes a control device including a control unit generating control signals and a selection unit outputting a selection signal. A signal amplifier coupled to the control unit amplifies signals from the control unit. A de-multiplexer has an input node coupled to the signal amplifier and a control node coupled to the selection unit. A tilt actuator coupled to the first node of the de-multiplexer controlling the tilt angle of a pick-up head and a tray motor coupled to the second node of the de-multiplexer.

### BACKGROUND OF THE INVENTION

1. Field of the Invention

The present invention provides a control system for controlling an optical disc drive. More particularly, the present invention provides a combined servo controller for controlling a pick-up head and a tray motor of an optical disc drive.

2. Description of the Prior Art

The control of an optical disc drive comprises spindle control, sledge motor control, pick-up head actuator control, and tray motor control. The pick-up head actuator control further comprises a focus control, a radial control, and a tilt control. Generally, the signal of the tilt control is close to that of the tray motor control. Thus, the tilt control and the tray motor control are usually combined in a main controller. In this way, the main controller can control the pick-up head actuator and the tray motor with different auxiliary controllers respectively.

Please refer to FIG. 1. FIG. 1 is a diagram illustrating a conventional control system 180 controlling the tilt actuator of the pick-up head and the tray motor. As shown in FIG. 1, the control system 180 comprises controller 100, a first amplifier 115, a second amplifier 120, a tilt actuator 125 of the pick-up head, and a tray motor 130. The controller 100 comprises a first control unit 105 and a second control unit 110.

Please refer to FIG. 2 with FIG. 1 together. FIG. 2 is a flowchart illustrating the conventional control system 180 controlling the tilt actuator of the pick-up head and tray motor. The steps are described as follows.

Step 200: Start.

Step 202: Controller 100 transmits a first control signal to the first control unit 105 and a second control signal to the second control unit 110.

Step 204A: The first control unit 105 transmits a third control signal to the first amplifier 115 according to the first control signal.

Step 204B: The second control unit 110 transmits a fourth control signal to the second amplifier 120 according to the second control signal.

Step 206A: The first amplifier 115 amplifies the third control signal, and transmits the amplified third control signal to the tilt actuator 125 of the pick-up head.

Step 206B: The second amplifier 120 amplifies the fourth control signal, and transmits the amplified fourth control signal to the tray motor 130.

Step 208A: The tilt actuator 125 generates a reaction according to the amplified third control signal.

Step 208B: The tray motor 130 generates a reaction according to the amplified fourth control signal.

Step 210: End.

The drawback of the conventional control system 180 is that the control system 180 uses 2 control units and 2 amplifiers to respectively control the tilt actuator of the pick-up head and the tray motor. That is, the conventional control system 180 uses more hardware components to operate. However, the tilt actuator of the pick-up head and the tray motor do not operate at the same time. Therefore, when the control unit of the tilt actuator is operating, the control unit of the tray motor idles, and vice versa.

### SUMMARY OF THE INVENTION

The present invention provides a control system for controlling a tilt actuator and a tray motor of an optical disc drive comprising a control device having a control unit for generating a control signal and a selection unit for outputting a selection signal. A signal amplifier is coupled to the control unit for amplifying the control signal from the control unit. A de-multiplexer comprises a first output end, a second output end, and an input end that is coupled to the signal amplifier. A control end of the de-multiplexer is coupled to the selection unit for receiving the selection signal. A tilt actuator is coupled to the first output end of the de-multiplexer for controlling a tilt angle of a pick-up head and a tray motor is coupled to the second output end of the de-multiplexer.

The present invention further provides a control system for controlling a pick-up head actuator and a tray motor of an optical disc drive. The control system includes a control device comprising a first control unit for generating a first control signal, a second control unit for generating a second control signal, and a selection unit for outputting a selection signal. A signal amplifier is coupled to the first control unit and the second control unit for amplifying the first control signal of the first control unit and the second control signal of the second control unit. A de-multiplexer comprises a first output end, a second output end, and an input end that is coupled to the signal amplifier. A control end of the de-multiplexer is coupled to the selection unit for receiving the selection signal. A pick-up head actuator is coupled to the first output end of the de-multiplexer for controlling a pick-up head and a tray motor is coupled to the second output end of the de-multiplexer.

The present invention further provides a control method for controlling a tilt actuator and a tray motor of an optical disc drive. The method includes a control device that transmits a first control signal to a control unit and a second control signal to a selection unit. The control unit transmits a third control signal to an amplifier according to the first control signal. The selection unit transmits a selection signal to a de-multiplexer according to the second control signal. The amplifier amplifies the third control signal, and transmits the amplified third control signal to the de-multiplexer. The de-multiplexer transmits the amplified third control signal to the tilt actuator or the tray motor according to the selection signal. The tilt actuator or the tray motor generating a reaction according to the amplified third control signal transmitted from the de-multiplexer.

The present invention further provides a control method for controlling a pick-up head actuator and a tray motor of an optical disc drive. The method comprises a control device selectively transmitting a first control signal to a first control unit or a second control signal to a second control unit. The first control unit transmits a third control signal according to the first control signal or the second control unit transmits a fourth control signal to an amplifier according to the second control signal. The amplifier amplifies the third control signal or the fourth control signal and transmits the amplified third control signal or the amplified fourth control signal to a de-multiplexer. The control device transmits a fifth control signal to a selection unit. The selection unit transmits a selection signal to the de-multiplexer according to the fifth control signal. The de-multiplexer transmits the amplified third control signal to the pick-up head actuator or the amplified fourth control signal to the tray motor according to the emitting selection signal from the selection unit. It is the pick-up head actuator or the tray motor to generate a reaction is according to the amplified signal coming from the first unit or the second unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional control system controlling the tilt actuator and the tray motor.

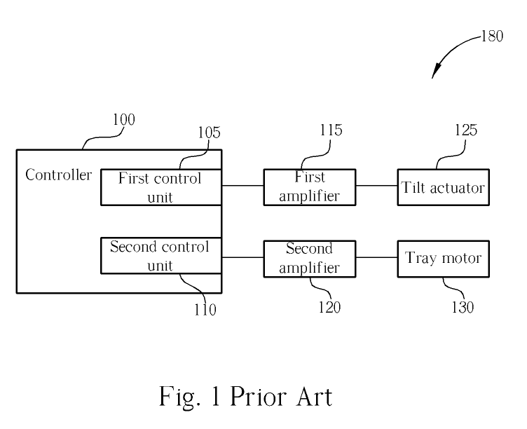

FIG. 2 is a flowchart illustrating the conventional control system controlling the tilt actuator and tray motor.

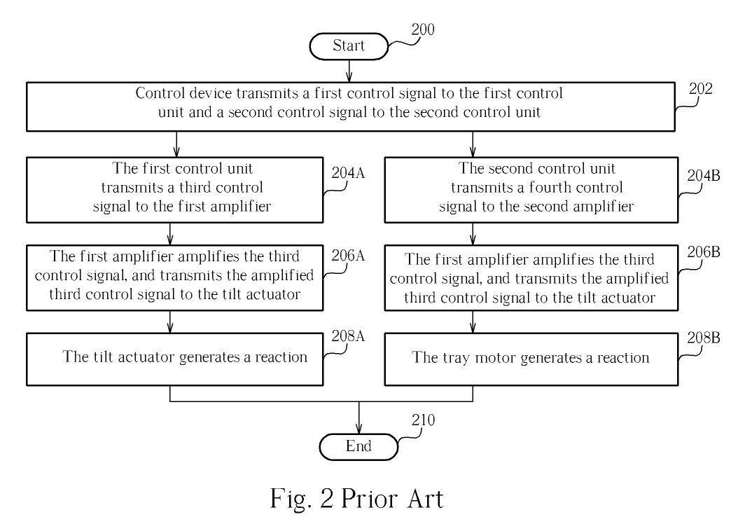

FIG. 3 is a diagram illustrating a control system of a first embodiment of the present invention.

FIG. 4 is a flowchart illustrating the control system of the first embodiment of the present invention.

FIG. 5 is a diagram illustrating a control system of a second embodiment of the present invention.

FIG. 6 is a flowchart illustrating the control system of the second embodiment of the present invention.

### DETAILED DESCRIPTION

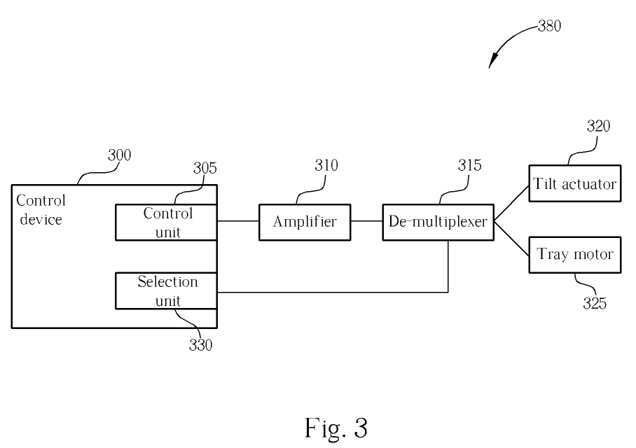

Please refer to FIG. 3. FIG. 3 is a diagram illustrating a control system 380 of a first embodiment of the present invention. The control system 380 comprises a control device 300, an amplifier 310, a de-multiplexer 315, a tilt actuator 320, and a tray motor 325. The control device 300 comprises a control unit 305 and a selection unit 330. The control device 300 transmits a first control signal to the control unit 305 and a second control signal to the selection unit 330. The control unit 305 transmits a third control signal to the amplifier 310 according to the first control signal. The selection unit 330 transmits a selection signal to the de-multiplexer 315 according to the second control signal. The amplifier 310 amplifies the third control signal and transmits the amplified third signal to the de-multiplexer 315. The de-multiplexer 315 transmits the amplified third signal to the tilt actuator 320 or the tray motor 325 according to the selection signal. The tilt actuator 320 or the tray motor 325 then generates a reaction.

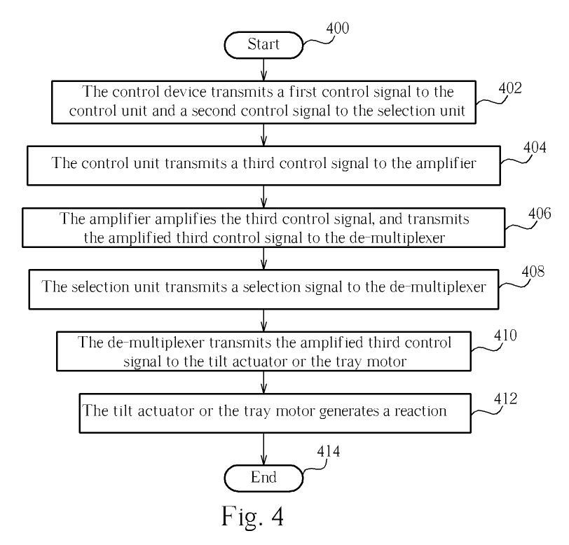

Please refer to FIG. 4. FIG. 4 is a flowchart illustrating the control system 380 of the first embodiment of the present invention controlling the tilt actuator of the pick-up head and tray motor. The steps are described as follows.

Step 400: Start.

Step 402: The control device 300 transmits a first control signal to the control unit 305 and a second control signal to the selection unit 330.

Step 404: The control unit 305 transmits a third control signal to the amplifier 310 according to the first control signal.

Step 406: The amplifier 310 amplifies the third control signal, and transmits the amplified third control signal to the de-multiplexer 315.

Step 408: The selection unit 330 transmits a selection signal to the de-multiplexer 315 to control the output end of the de-multiplexer 315 coupled to the tilt actuator 320 or the tray motor 325 according to the second control signal.

Step 410: The de-multiplexer 315 transmits the amplified third control signal to the tilt actuator 320 or the tray motor 325 according to the step 408.

Step 412: The tilt actuator 320 or the tray motor 325 generates a reaction according to the amplified third control signal.

Step 414: End.

To achieve the above steps, the signal to control the tilt actuator and the signal to control the tray motor have to be arranged in the same format. In this way, the tilt actuator and the tray motor can be controlled by one control signal such as the third control signal described above. Thus, the 2 control units of the conventional control system 180 can be reduced to one control unit 305, and the 2 amplifiers of the conventional control system 180 can be reduced to one amplifier 310.

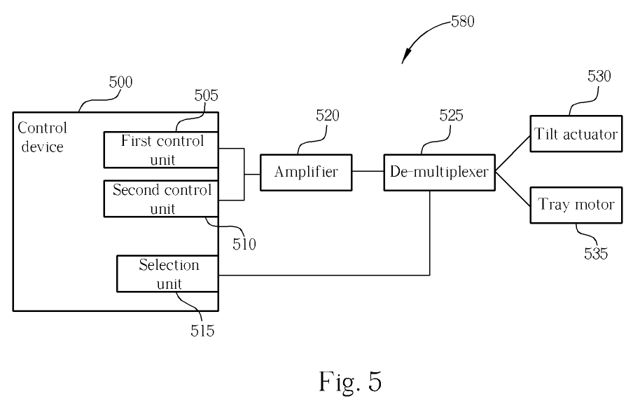

Please refer to FIG. 5. FIG. 5 is a diagram illustrating a control system 580 of a second embodiment of the present invention. The control system 580 comprises a control device 500, an amplifier 520, a de-multiplexer 525, a tilt actuator 530, and a tray motor 535. The control device 500 comprises a first control unit 505, a second control unit 510, and a selection unit 515. The control device 500 generates a first control signal to the first control unit 505 or a second control signal to the second control unit 510, and generates a third control signal to the selection unit 515. The first control unit 505 transmits a fourth control signal to the amplifier 520 according to the first control signal. The second control unit 510 transmits a fifth control signal to the amplifier 520 according to the second control signal. The selection unit 515 transmits a selection signal to the de-multiplexer 525 according to the third control signal. The amplifier 520 amplifies the fourth control signal or the fifth control signal and then transmits the signals to the de-multiplexer 525. The de-multiplexer 525 transmits the fourth control signal to the tilt actuator 530 or the fifth control signal to the tray motor 535.

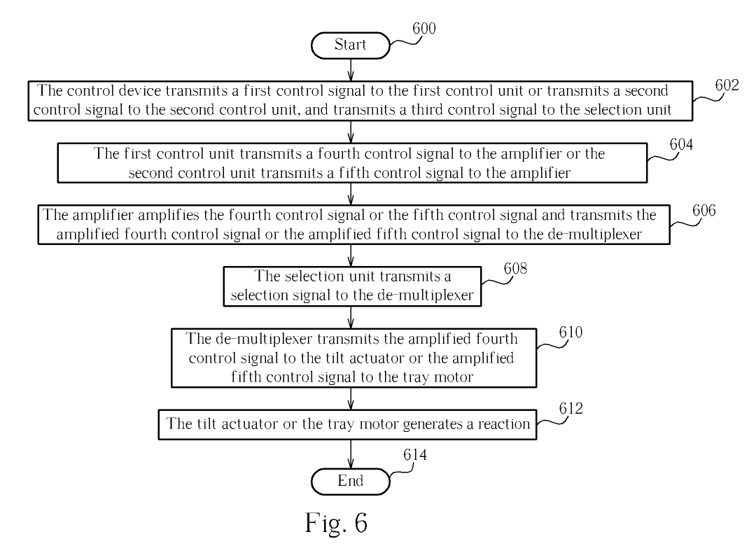

Please refer to FIG. 6. FIG. 6 is a flowchart illustrating the control system 580 of the second embodiment of the present invention controlling the tilt actuator of the pick-up head and tray motor. The steps are described as follows.

Step 600: Start.

Step 602: The control device 500 transmits a first control signal to the first control unit 505 or transmits a second control signal to the second control unit 510, and transmits a third control signal to the selection unit 515.

Step 604: The first control unit 505 transmits a fourth control signal to the amplifier 520 or the second control unit 510 transmits a fifth control signal to the amplifier 520.

Step 606: The amplifier 520 amplifies the fourth control signal or the fifth control signal and transmits the amplified fourth control signal or the amplified fifth control signal to the de-multiplexer 525.

Step 608: The selection unit 515 transmits a selection signal to the de-multiplexer 525 according to the third control signal.

Step 610: The de-multiplexer 525 transmits the amplified fourth control signal to the tilt actuator 530 or the amplified fifth control signal to the tray motor 530 according to the selection signal.

Step 612: The tilt actuator 530 or the tray motor generates a reaction.

Step 614: End.

In the second embodiment of the present invention, the format of the control signal of the tilt actuator 530 and that of the tray motor 535 can be different since the tilt actuator 530 and the tray motor 535 belong to different control units. Besides, in this embodiment, compared with the conventional control system, an amplifier is reduced.

Additionally, when the first control unit 505 is transmitting the fourth control signal to control the tilt actuator 530, and the control device 500 is about to transmit a second control signal to the second control unit 510, the control device 500 waits until the first control unit 505 finishes transmitting and the tilt actuator 530 finishes the corresponding reaction. Then the control device 500 transmits the second control signal to the second control unit 510, and vice versa. Or, one of the first control unit 505 and the second control unit 510 has a higher priority. For example, when the first control unit 505 is transmitting the fourth control signal to control the tilt actuator 530, and the control device 500 is about to transmit the second control signal to the second control unit 510 to control the tray motor 535, the first control unit 505 pauses transmitting the fourth control signal, that is, the tilt actuator 530 pauses generating the reaction, to allow the second control unit 510 to transmit the fifth control signal and the tray motor 530 to generate a reaction. This design described above avoids the interference between the two control units.

In the control system 580 of the second embodiment of the present invention, the first control unit 505 and the second control unit 510 can respectively control the tilt actuator 530 and the tray motor 535. However, the tilt actuator 530 can be replaced with a radial actuator or a focus actuator. For example, if the tilt actuator 530 is replaced with the radial actuator, the 2 control units 505 and 510 are used for respectively controlling the radial actuator and the tray motor. If the tilt actuator 530 is replaced with the focus actuator, the 2 control units 505 and 510 are used for respectively controlling the focus actuator and the tray motor.

The embodiments of the present invention both increase the efficiency of an optical disc drive and reduce the hardware components of the optical disc drive.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control system for controlling a tilt actuator and a tray motor of an optical disc drive comprising:
a control device comprising:
a control unit for generating a control signal; and
a selection unit for outputting a selection signal;
a signal amplifier coupled to the control unit for amplifying the control signal from the control unit;
a de-multiplexer comprising:
an input end coupled to the signal amplifier;
a control end coupled to the selection unit for receiving the selection signal;
a first output end; and
a second output end;
a tilt actuator coupled to the first output end of the de-multiplexer for controlling a tilt angle of a pick-up head; and
a tray motor coupled to the second output end of the de-multiplexer.

2. A control system for controlling a pick-up head actuator and a tray motor of an optical disc drive comprising:
a control device comprising:
a first control unit for generating a first control signal;
a second control unit for generating a second control signal; and
a selection unit for outputting a selection signal;
a signal amplifier coupled to the first control unit and the second control unit for amplifying the first control signal of the first control unit and the second control signal of the second control unit;
a de-multiplexer comprising:
an input end coupled to the signal amplifier;
a control end coupled to the selection unit for receiving the selection signal;
a first output end; and
a second output end;
a pick-up head actuator coupled to the first output end of the de-multiplexer for controlling a pick-up head; and
a tray motor coupled to the second output end of the de-multiplexer.

3. The control system of claim 2 wherein the pick-up head actuator is a tilt actuator for controlling a tilt angle of the pick-up head.

4. The control system of claim 2 wherein the pick-up head actuator is a focus actuator for controlling a focus of the pick-up head.

5. The control system of claim 2 wherein the pick-up head actuator is a radial actuator for controlling a radial position of the pick-up head.

6. A control method for controlling a tilt actuator and a tray motor of an optical disc drive comprising:
a control device transmitting a first control signal to a control unit and a second control signal to a selection unit;
the control unit transmitting a third control signal to an amplifier according to the first control signal;
the selection unit transmitting a selection signal to a de-multiplexer according to the second control signal;
the amplifier amplifying the third control signal, and transmitting the amplified third control signal to the de-multiplexer;
the de-multiplexer transmitting the amplified third control signal to the tilt actuator or the tray motor according to the selection signal; and
the tilt actuator or the tray motor generating a reaction according to the amplified third control signal transmitted from the de-multiplexer.

7. A control method for controlling a pick-up head actuator and a tray motor of an optical disc drive comprising:
a control device selectively transmitting a first control signal to a first control unit or a second control signal to a second control unit;
the first control unit transmitting a third control signal according to the first control signal or the second control unit transmitting a fourth control signal according to the second control signal to an amplifier;
the amplifier amplifying the third control signal or the fourth control signal, and transmitting the amplified third control signal or the amplified fourth control signal to a de-multiplexer;
the control device transmitting a fifth control signal to a selection unit;
the selection unit transmitting a selection signal to the de-multiplexer according to the fifth control signal;
the de-multiplexer transmitting the amplified third control signal to the pick-up head actuator or the amplified fourth control signal to the tray motor according to the selection signal; and
the pick-up head actuator generating a reaction according to the amplified third control signal or the tray motor generating a reaction according to the amplified fourth control signal.

8. The control method of claim 7 wherein the pick-up head actuator is a tilt actuator.

9. The control method of claim 7 wherein the pick-up head actuator is a radial actuator.

10. The control method of claim 7 wherein the pick-up head actuator is a focus actuator.
